(19) United States
(12) Patent Application Publication
(10) Pub. No.: US 2024/0422784 A1
(43) Pub. Date: Dec. 19, 2024

(54) METHODS AND DEVICES FOR REPETITION TRANSMISSION

(71) Applicant: ZTE CORPORATION, Shenzhen (CN)

(72) Inventors: Xing LIU, Shenzhen (CN); Xianghui HAN, Shenzhen (CN); Peng HAO, Shenzhen (CN); Jing SHI, Shenzhen (CN); Junfeng ZHANG, Shenzhen (CN)

(73) Assignee: ZTE CORPORATION, Shenzhen (CN)

(21) Appl. No.: 18/815,020

(22) Filed: Aug. 26, 2024

Related U.S. Application Data
(63) Continuation of application No. PCT/CN2022/138083, filed on Dec. 9, 2022.

(51) Int. Cl. H04W 72/21; H04B 17/318; H04W 74/0833

(52) U.S. Cl. CPC H04W 72/21; H04B 17/328; H04W 74/0833

(57) ABSTRACT

The present disclosure describes methods, system, and devices for indicating and/or configuring repetition transmission of physical uplink shared channel (PUSCH). One method includes sending, by a user equipment (UE) to a base station, a request or a capability indication for a repetition of a first PUSCH transmission; and receiving, by the UE from the base station, a repetition factor indication for the repetition of the first PUSCH transmission. Another method includes receiving, by a base station from a UE, a request or capability indication for a repetition of a first PUSCH transmission; and, sending, by the base station to UE from, a repetition factor indication for the repetition of the first PUSCH transmission.

### CROSS-REFERENCE TO RELATED APPLICATION

This application claims the benefit of priority under 35 U.S.C. § 120 as a continuation of International Patent Application No. PCT/CN2022/138083, filed on Dec. 9, 2022, the disclosure of which is incorporated herein by reference in its entirety.

### TECHNICAL FIELD

The present disclosure is directed generally to wireless communications. Particularly, the present disclosure relates to methods and devices for indicating and/or configuring repetition transmission of physical uplink shared channel (PUSCH).

### BACKGROUND

Wireless communication technologies are moving the world toward an increasingly connected and networked society. In wireless communication system, a physical uplink shared channel (PUSCH) may be one of the potential coverage bottleneck channels among physical channels for uplink transmission, and enhancements to the PUSCH may be needed to meet the increasing demands. Repetition of the PUSCH transmission is one of effective ways to improve coverage, but there are at least one issues/problems. For example, one problem may be how to support repetition for PUSCH transmission; and/or another problem may be how to identify one or more UE has the repetition transmission capability.

The present disclosure describes various embodiments for indicating and/or configuring repetition of PUSCH transmission, addressing at least one of issues/problems associated with repetition of PUSCH transmission, providing improvement in the technology field of wireless communication and increasing its efficiency and performance.

### SUMMARY

This document relates to methods, systems, and devices for configuring measurement subband configuration for indicating and/or configuring repetition transmission of physical uplink shared channel (PUSCH).

In one embodiment, the present disclosure describes a method for wireless communication. The method includes sending, by a user equipment (UE) to a base station, a request or a capability indication for a repetition of a first physical uplink shared channel (PUSCH) transmission; and receiving, by the UE from the base station, a repetition factor indication for the repetition of the first PUSCH transmission.

In one embodiment, the present disclosure describes a method for wireless communication. The method includes receiving, by a base station from a user equipment (UE), a request or capability indication for a repetition of a first physical uplink shared channel (PUSCH) transmission; and, sending, by the base station to UE from, a repetition factor indication for the repetition of the first PUSCH transmission.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of one non-limiting embodiment for wireless communication.

FIG. 1C shows a schematic diagram of another non-limiting embodiment for wireless communication.

FIG. 1D shows a schematic diagram of another non-limiting embodiment for wireless communication.

FIG. 2 shows an example of a network node.

FIG. 3 shows an example of a user equipment.

FIG. 4 shows a flow diagram of a method for wireless communication.

FIG. 5 shows a flow diagram of another method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for indicating and/or configuring repetition transmission of physical uplink shared channel (PUSCH).

Next generation (NG), or 5th generation (5G), wireless communication may provide a range of capabilities from downloading with fast speeds to support real-time low-latency communication. New generation (NG) mobile communication system are moving the world toward an increasingly connected and networked society. To meet more and more demands, the new generation mobile communication technology (e.g., new radio (NR), 5G, 6G)) are developing supports on enhancing coverages, as overages are one of the key factors that an operator considers when commercializing cellular communication networks and coverage may have direct impact on service quality as well as capital expenditure (CAPEX) and operation expense (OPEX).

Among physical channels for uplink transmission, PUSCH may be one of the potential coverage bottleneck channels and corresponding enhancements are needed. Repetition transmission is one of effective methods to improve coverage. In some implementations, for the PUSCH during initial access procedure, i.e., initial transmission of Msg.3 that is a PUSCH scheduled by random access response (RAR) uplink (UL) grant and retransmission of Msg.3 that is a PUSCH scheduled by downlink control information (DCI) format 0_0 with cyclic redundancy check (CRC) scrambled by a temporary cell-radio network temporary identifier (TC-RNTI), repetition transmission scheme may be specified. In some implementations, for the PUSCH after radio resource control (RRC) reconfiguration, repetition transmission may be supported. Various issues/problems may associate with repetition transmission for PUSCH which is after initial access and before the RRC reconfiguration message is received, and thus, the coverage of PUSCH transmission during this period may remain a bottleneck.

The present disclosure describes methods, wireless communication devices, wireless communication nodes, wireless apparatus, and/or wireless systems for indicating and/or configuring repetition transmission of PUSCH, addressing at least one of the issues/problems discussed above, for example, how to support repetition for PUSCH transmission, how to identify that UEs have the repetition transmission capability, how to indicate the repetition number, etc. With various embodiments in the present disclosure, the repetition of PUSCH transmission may be triggered and/or requested effectively; the related UE capability may be reported in time for PUSCH transmission before RRC reconfiguration; a repetition factor may be indicated for the PUSCH transmission. The efficient support of repetition for the bottleneck PUSCH transmission may improve overall coverage and network efficiency.

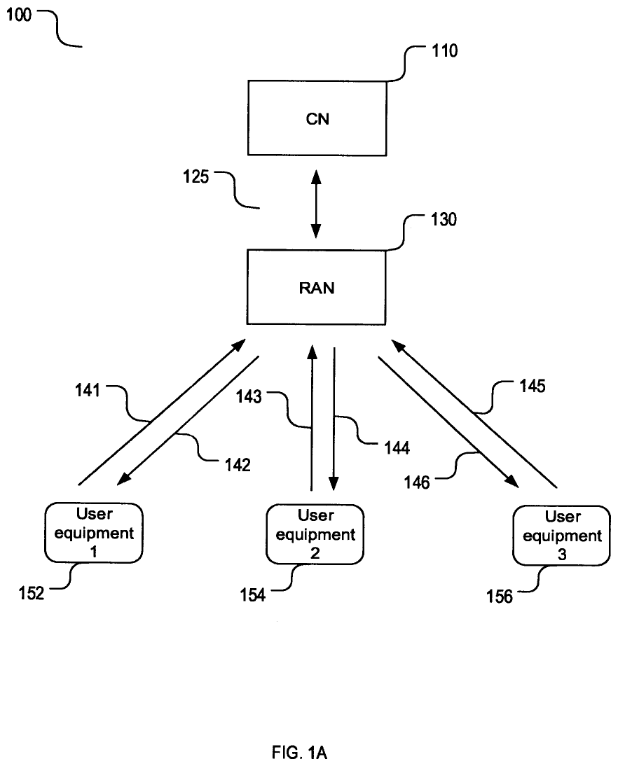

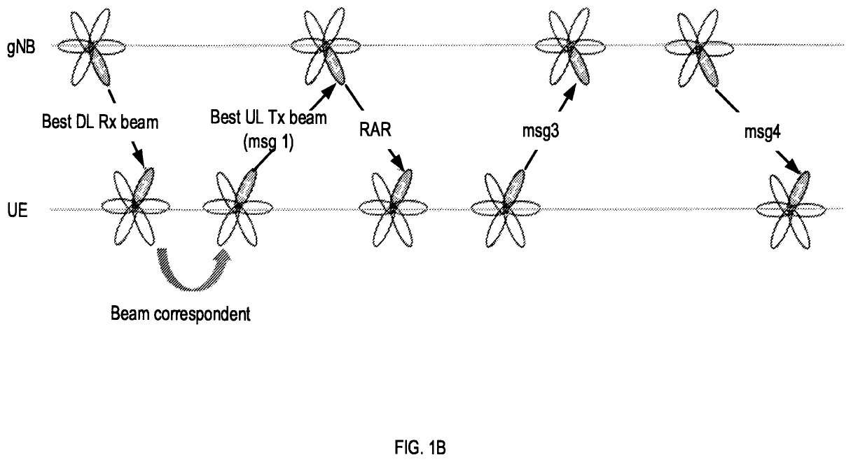

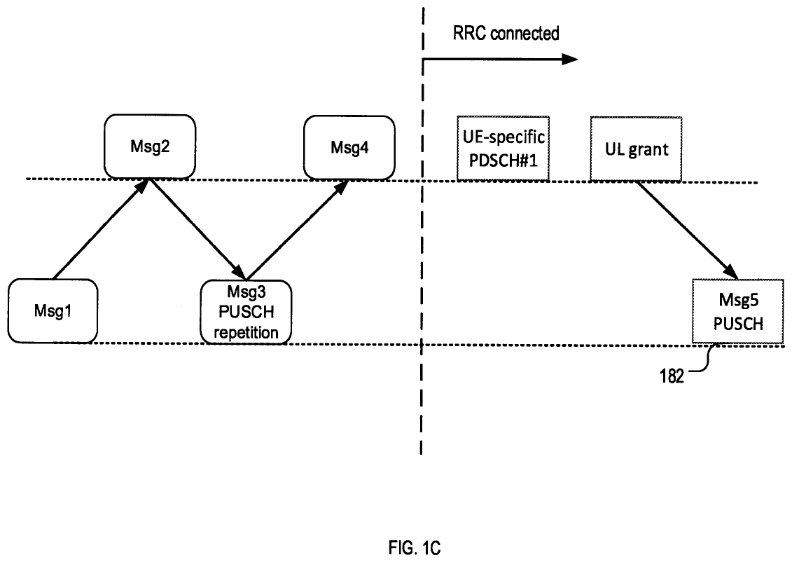

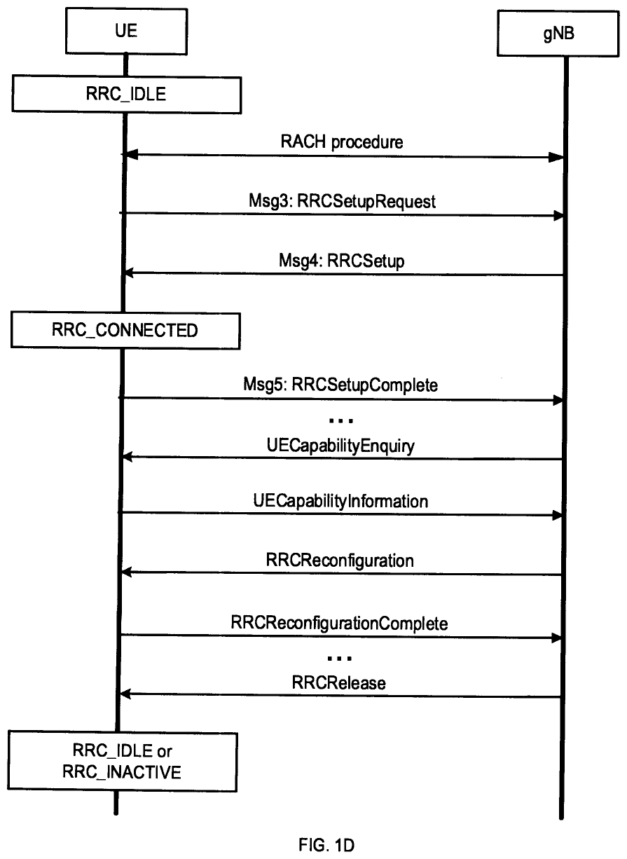

FIG. 1A shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and an uplink communication may include a physical uplink shared channel (PUSCH) or a physical uplink control channel (PUCCH).

In some implementations, NR has introduced a basic scheme to support the initial access under a first frequency range (FR1, sub 6G Hz band) and a second frequency range (FR2, beyond 6G Hz band). One of the steps is the transmission of PRACH, which can also be called as msg.1 (Msg1). The related scheme includes different PRACH formats, PRACH resource configurations, the relationship between the SSB (synchronization signal/PBCH block) and PRACH occasion, the mechanism of PRACH retransmission, the mechanism of PRACH power control, etc.

In some implementations, referring to FIG. 1B, an example of RACH procedure is showed. A UE may transmit a preamble in PRACH occasion (RO), according to the configuration of PRACH transmission and the SSB it selected. During this step, when the transmission-reception correspondence of UE side may be guaranteed, there may be a fixed mapping between the UE's receiving beam (Rx beam) and the UE's transmitting beam (Tx beam). Then, a unique Tx beam may be determined according to its receiving of the SSB. Specifically, the UE may try to use different Rx beams to receive the SSB from the base station (BS), and determine the best or suitable Rx beam (e.g., with a highest reference signal received power (RSRP)). Then, according to the best or suitable Rx beam, the best Tx or suitable beam is determined. The RO used for transmitting the PRACH may be determined according to the relationship between the SSB and PO. Basing on the relationship, the BS may determine the SSB which may be selected by the UE. The same beam may be used for transmitting subsequent downlink (DL) transmissions, including msg.2 (Msg.2), which may also be called as RAR, and msg.4 (Msg.4), which is a PDSCH with UE contention resolution identity. According to the legacy RACH procedure, RAR may be received within an RAR window after the transmission of PRACH. The RAR window starts at the first symbol of the earliest control resource set (CORESET) after the end of PRACH transmission, in which the UE is configured to receive PDCCH for Type1-PDCCH CSS set. Then, the received PDCCH may schedule a PDSCH carrying the RAR, in which a RAR uplink (UL) grant may be obtained. The RAR UL grant is used for scheduling Msg.3 PUSCH. When the BS successfully receives the Msg.3 PUSCH, it sends the Msg.4 to the UE. The above procedure may be called as 4-step RACH procedure which is typically applied to an initial access process. To improve coverage of this process, the Msg.3 PUSCH already supports repetition transmission.

In some implementations, referring to FIG. 1C, after UE performing 4-step RACH procedure, the BS may schedule another PUSCH transmission, which may be called as Msg.5, to complete the radio resource control (RRC) setup. The higher layer signaling RRCsetupcomplete may be carried in Msg.5 PUSCH (Msg.5), which is scheduled by DCI format 0_0 with CRC scrambled by cell-RNTI (C-RNTI), cannot be scheduled with repetition. It means Msg.5 may then become the coverage bottleneck after Msg.3 PUSCH repetition is implemented. In some implementations, a Msg.5 PUSCH (182) may not be scheduled with PUSCH repetition due to a portion or all of the following reasons: PUSCH scheduled by DCI format 0_0 scrambled by C-RNTI does not support PUSCH repetition; and/or even if supported, NW doesn't know whether the UE has such capability before Msg.5 transmission.

In some implementations, a PUSCH repetition may be a UE capability, that is, only when a UE reports that it supports the capability or the UE requests the repetition transmission, the BS may schedule the PUSCH transmission with repetition. For Msg.3 PUSCH repetition, including initial transmission and/or retransmission, some specific PRACH resource (e.g., preamble, RO, etc.) are configured to the UE. When the UE uses this resource for the PRACH transmission, the BS may know that the UE supports Msg.3 PUSCH repetition transmission or the UE requests the Msg.3 PUSCH repetition transmission.

In some implementations, referring to FIG. 1D, the UE may report its capability by transmitting another PUSCH carrying a higher layer parameter ‘UECapabilityInformation’ in response to receive an higher layer parameter ‘UECapabilityEnquiry’ from the BS. The BS may configure PUSCH repetition related transmission parameters, for non-limiting example., pusch-AggregationFactor via RRCReconfiguration, and indicate PUSCH repetition via DCI. This method may be used for PUSCH after RRCReconfiguration. When a UE expects to use repetition transmission for the PUSCH carrying the ‘UECapabilityInformation’, the capability report should be earlier than that.

The present disclosure describes methods, wireless communication devices, wireless communication nodes, wireless apparatus, and/or wireless systems for indicating and/or configuring repetition transmission of PUSCH, wherein, for a PUSCH, which is transmitted before RRCReconfiguration and isn't scheduled by RAR UL grant or DCI format 0-0 with CRC scrambled by TC-RNTI, repetition transmission for this PUSCH may be supported. Typically, such PUSCH may be a Msg.5 PUSCH (carrying RRCSetupComplete) or a PUSCH carrying the ‘UECapability Information’.

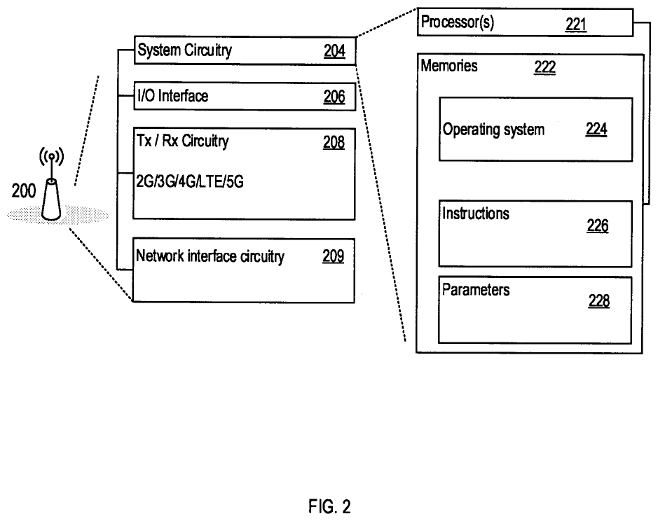

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

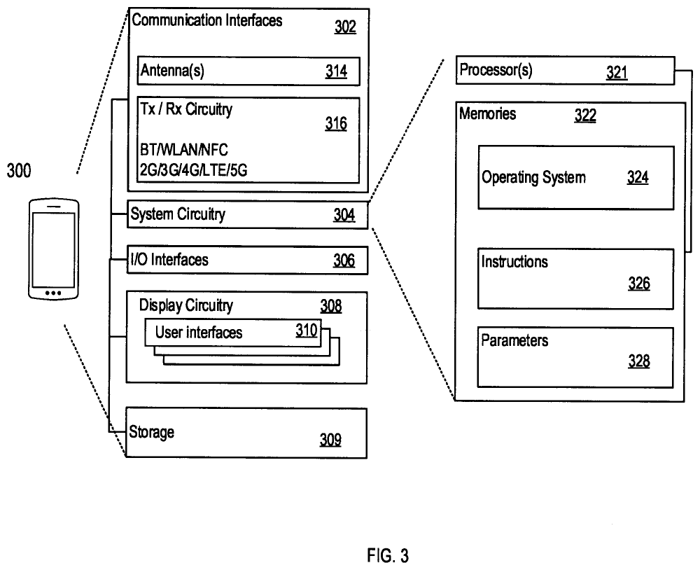

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments of methods and devices for indicating and/or configuring repetition transmission of PUSCH, which may be implemented, partly or totally, on the wireless network base station (or called wireless communication node) and/or the user equipment (or called wireless communication device) described above in FIGS. 2 and 3.

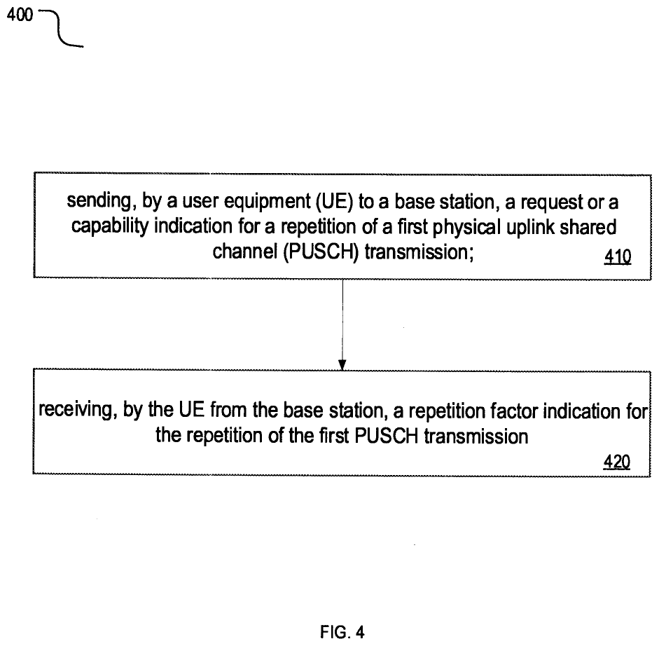

In various embodiments, FIG. 4 shows a flow diagram of a method 400 for wireless communication. The method 400 may include a portion or all of the following steps: step 410, sending, by a user equipment (UE) to a base station, a request or a capability indication for a repetition of a first physical uplink shared channel (PUSCH) transmission; and/or step 420, receiving, by the UE from the base station, a repetition factor indication for the repetition of the first PUSCH transmission.

In some implementations, the method 400 may further include after sending a second PUSCH transmission and/or before sending a third PUSCH transmission, transmitting, by the UE to the base station, the repetition of the first PUSCH transmission; wherein: the second PUSCH transmission comprises one of a PUSCH scheduled by a random access response (RAR) uplink (UL) grant, and/or a PUSCH scheduled by a downlink control information (DCI) format 0_0 with a cyclic redundancy check (CRC) scrambled by a temporary cell-radio network temporary identifier (TC-RNTI), or the third PUSCH transmission comprises a PUSCH carrying radio resource control (RRC) reconfiguration complete information.

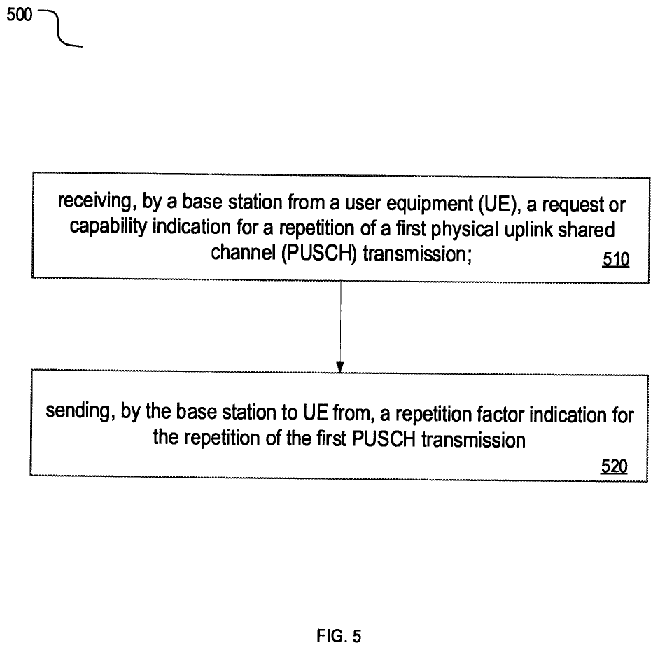

In various embodiments, FIG. 5 shows a flow diagram of a method 500 for wireless communication. The method 500 may include a portion or all of the following steps: step 510, receiving, by a base station from a user equipment (UE), a request or capability indication for a repetition of a first physical uplink shared channel (PUSCH) transmission; and/or step 520, sending, by the base station to UE from, a repetition factor indication for the repetition of the first PUSCH transmission.

In some implementations, the method 500 may further include after receiving a second PUSCH transmission and/or before receiving a third PUSCH transmission, receiving, by the base station from the UE, the repetition of the first PUSCH transmission; wherein: the second PUSCH transmission comprises one of a PUSCH scheduled by a random access response (RAR) uplink (UL) grant, or a PUSCH scheduled by a downlink control information (DCI) format 0_0 with a cyclic redundancy check (CRC) scrambled by a temporary cell-radio network temporary identifier (TC-RNTI), and/or the third PUSCH transmission comprises a PUSCH carrying radio resource control (RRC) reconfiguration complete information.

In some implementations, in combination of a portion or all of one or more implementations or embodiments described in the present disclosure, the first PUSCH transmission comprises at least one of the following: a PUSCH carrying RRC setup complete information, a PUSCH carrying UE capability information, a PUSCH scheduled by a DCI format 0_0 with a CRC scrambled by a cell-RNTI (C-RNTI), a configured scheduling (CS-RNTI), or a modulation and coding scheme cell-RNTI (MCS-C-RNTI), and/or a PUSCH scheduled by a DCI format 0_1 with a CRC scrambled by a cell-RNTI (C-RNTI), a configured scheduling (CS-RNTI), or a modulation and coding scheme cell-RNTI (MCS-C-RNTI),

In some implementations, in combination of a portion or all of one or more implementations or embodiments described in the present disclosure, the UE sends the request or the capability indication for the repetition of the first PUSCH transmission in response to at least one of the following triggering conditions: a synchronization signal (SS) reference signal received power (RSRP) measured by the UE being lower than an RSRP threshold, the UE having requested repetition of the second PUSCH transmission, and/or the repetition of the second PUSCH transmission being scheduled for the UE.

In some implementations, in combination of a portion or all of one or more implementations or embodiments described in the present disclosure, the RSRP threshold is scheduled by one of the following: via a higher layer parameter, and/or via a high layer parameter and an offset value.

In some implementations, in combination of a portion or all of one or more implementations or embodiments described in the present disclosure, the request or the capability indication for the repetition of the first PUSCH transmission via at least one of the following: a PRACH resource from a first PRACH resource set corresponding to the repetition of the first PUSCH transmission, signalling information in the second PUSCH, and/or a transmission status of the second PUSCH transmission and an indication information in the second PUSCH.

In some implementations, in combination of a portion or all of one or more implementations or embodiments described in the present disclosure, the PRACH resource comprises at least one of a preamble sequence resource or a RACH occasion resource.

In some implementations, in combination of a portion or all of one or more implementations or embodiments described in the present disclosure, the request or the capability indication for the repetition of the first PUSCH transmission via the signalling information in the second PUSCH comprises: setting the signalling information as a first value, representing that the UE has the capability or requests for the repetition of the first PUSCH transmission, and/or setting the signalling information as a second value, representing that the UE does not have the capability or request for the repetition of the first PUSCH transmission.

In some implementations, in combination of a portion or all of one or more implementations or embodiments described in the present disclosure, the request or the capability indication for the repetition of the first PUSCH transmission via the transmission status of the second PUSCH transmission and the indication information in the second PUSCH comprises at least one of the following: in response to the UE having requested repetition of the second PUSCH transmission, setting no indication information in the second PUSCH, representing that the UE has the capability or requests for the repetition of the first PUSCH transmission, in response to the UE having requested repetition of the second PUSCH transmission, setting the indication information in the second PUSCH, representing that the UE does not have the capability or request for the repetition of the first PUSCH transmission, in response to the UE does not request repetition of the second PUSCH transmission, setting no indication information in the second PUSCH, representing that the UE does not have the capability or request for the repetition of the first PUSCH transmission, and/or in response to the UE does not request repetition of the second PUSCH transmission, setting the indication information in the second PUSCH, representing that the UE has the capability or requests for the repetition of the first PUSCH transmission.

In some implementations, in combination of a portion or all of one or more implementations or embodiments described in the present disclosure, the request or the capability indication for the repetition of the first PUSCH transmission via the transmission status of the second PUSCH transmission and the indication information in the second PUSCH comprises at least one of the following: in response to the UE having requested repetition of the second PUSCH transmission, representing that the UE has the capability or requests for the repetition of the first PUSCH transmission, in response to that the UE does not request repetition of the second PUSCH transmission, setting the indication information in the second PUSCH to a first value, representing that the UE does not have the capability or request for the repetition of the first PUSCH transmission, and/or in response to that the UE does not request repetition of the second PUSCH transmission, setting the indication information in the second PUSCH to a second value, representing that the UE has the capability or requests for the repetition of the first PUSCH transmission.

In some implementations, in combination of a portion or all of one or more implementations or embodiments described in the present disclosure, the request or capability indication for the repetition of the first PUSCH transmission via the transmission status of the second PUSCH transmission and the indication information in the second PUSCH comprises at least one of the following: in response to the UE having requested repetition of the second PUSCH transmission, representing that the UE has the capability or requests for the repetition of the first PUSCH transmission, in response to that the UE does not request repetition of the second PUSCH transmission, the present of the indication information in the second PUSCH, representing that the UE does not have the capability or request for the repetition of the first PUSCH transmission, and/or in response to that the UE does not request repetition of the second PUSCH transmission, the absent of the indication information in the second PUSCH, representing that the UE has the capability or requests for the repetition of the first PUSCH transmission.

In some implementations, in combination of a portion or all of one or more implementations or embodiments described in the present disclosure, the request or capability indication for the repetition of the first PUSCH transmission via the transmission status of the second PUSCH transmission and the indication information in the second PUSCH comprises at least one of the following: in response to that the UE does not request repetition of the second PUSCH transmission, representing that the UE does not have the capability or request for the repetition of the first PUSCH transmission, in response to the UE having requested repetition of the second PUSCH transmission, setting the indication information in the second PUSCH to a first value, representing that the UE does not have the capability or request for the repetition of the first PUSCH transmission, and/or in response to that the UE does not request repetition of the second PUSCH transmission, setting the indication information in the second PUSCH to a second value, representing that the UE has the capability or requests for the repetition of the first PUSCH transmission.

In some implementations, in combination of a portion or all of one or more implementations or embodiments described in the present disclosure, the request or capability indication for the repetition of the first PUSCH transmission via the transmission status of the second PUSCH transmission and the indication information in the second PUSCH comprises at least one of the following: in response to that the UE does not request repetition of the second PUSCH transmission, representing that the UE does not have the capability or request for the repetition of the first PUSCH transmission, in response to the UE having requested repetition of the second PUSCH transmission, the present of the indication information in the second PUSCH, representing that the UE has the capability or requests for the repetition of the first PUSCH transmission, and/or in response to that the UE does not request repetition of the second PUSCH transmission, the absent of the indication information in the second PUSCH, representing that the UE does not have the capability or request for the repetition of the first PUSCH transmission.

In some implementations, in combination of a portion or all of one or more implementations or embodiments described in the present disclosure, the UE receives, from the base station, the repetition factor indication for the repetition of the first PUSCH transmission by at least one of the following: a higher layer parameter for configuring the repetition factor, a higher layer parameter for configuring a list of repetition factors and a signalling in a DCI for indicating the repetition factor in the list of repetition factors, a higher layer parameter for configuring a list of M repetition factors and log₂M most significant bits (MSBs) of a modulation and coding scheme (MCS) field in a DCI for indicating the repetition factor in the list of M repetition factors, M being a positive integer, and/or a higher layer parameter for configuring a list of N repetition factors and ┌log₂N┐ most significant bits (MSBs) of a modulation and coding scheme (MCS) field in a DCI for indicating the repetition factor in the list of N repetition factors, N being a positive integer and ┌ ┐ representing a ceiling function.

In some implementations, in combination of a portion or all of one or more implementations or embodiments described in the present disclosure, a configured list of repetition factors for repetition of the second PUSCH transmission is used for indicating repetition factor for repetition of the first PUSCH transmission, in response to that the higher layer parameter for configuring the list of M repetition factors for repetition of the first PUSCH transmission is not provided; and/or a repetition factor list {1, 2, . . . , M} or {1, 2, . . . , N} is used for indicating repetition factor for repetition of the first PUSCH transmission, in response to that both of the list of M or N repetition factors for repetition of the first PUSCH transmission and configured list of repetition factors for repetition of the second PUSCH transmission are not provided.

In some implementations, in combination of a portion or all of one or more implementations or embodiments described in the present disclosure, 5−log₂M or 5−┌log₂N┐ least significant bits (LSBs) of an MCS field in a DCI indicates an MCS index from a list of MCS indexes for the first PUSCH transmission, a higher layer parameter is used for configuring the list of MCS indexes for the first PUSCH transmission, a list of MCS indexes configured for the second PUSCH transmission is used for indicating the MCS index of the first PUSCH transmission, in response to that the higher layer parameter for configuring the list of MCS indexes for the first PUSCH transmission is not provided, and/or a MCS index list {0, 1, 2, . . . , P−1} is used for indicating the MCS index for the first PUSCH transmission, in response to that both of the list of MCS indexes for the first PUSCH transmission and the list of MCS indexes for the second PUSCH transmission are not provided, P being a positive integer.

### Embodiment 1

The present disclosure describes non-limiting embodiments for defining the trigger condition of repetition transmission. Some trigger conditions may be defined for a UE to determine whether to request the repetition transmission for PUSCH before RRC Reconfiguration (i.e., before receiving a higher layer parameter carrying ‘RRCReconfiguration’). The PUSCH before RRC reconfiguration may be a PUSCH carrying a higher layer parameter ‘RRCSetupComplete’ (e.g., Msg.5 PUSCH) or a PUSCH carrying a higher layer parameter ‘UECapabilityInformation’. In some embodiments, the PUSCH is scheduled by a DCI format 0_0 or DCI format 0_1 with CRC scrambled by a C-RNTI or CS-RNTI or MCS-C-RNTI.

The trigger conditions may be at least one method of the following methods.

For a first method, a synchronization signal (SS)-RSRP threshold is configured to the UE. The UE measures the RSRP of SS (e.g.,a secondary synchronization signal) or reference signal (e.g., a demodulation reference signal for Physical broadcast channel or Channel-state information reference signal) and determines whether the measurement result is lower than the SS-RSRP theshold. When the measurement result is lower than the SS-RSRP threshold, the UE may determine to request the repetition transmission for PUSCH before receiving RRC Reconfiguration. In some other implementations, the SS-RSRP may be called as synchronization signal block (SSB)-RSRP.

In some implementations, the SS-RSRP threshold may be configured by a higher layer parameter, e.g., ‘rsrp-ThresholdMsg3’ which is also used for triggering repetition request for Msg.3 PUSCH transmission. Alternatively, the SS-RSRP threshold may be obtained according to the higher layer parameter ‘rsrp-ThresholdMsg3’ and an offset value. For example, the SS-RSRP threshold equals the value of higher layer parameter ‘rsrp-ThresholdMsg3’ plus the offset.

In some implementations, the SS-RSRP threshold is configured via either one of SIB1, random access response (or called as RAR or Msg.2), PDSCH with UE contention resolution identity (or called as Msg.4).

In some implementations, the offset value is configured via either one of SIB1,random access response (or called as RAR or Msg.2), PDSCH with UE contention resolution identity (or called as Msg.4) or provided in the standard.

For a second method, when a UE has requested repetition transmission of Msg.3 PUSCH (i.e., a PUSCH scheduled by RAR UL grant or by DCI format 0-0 with CRC scrambled by TC-RNTI), it means that the repetition transmission for PUSCH before RRC reconfiguration (i.e., before receiving a higher layer parameter carrying ‘RRCReconfiguration’) has been triggered.

In some implementations, alternatively, when a repetition transmission of Msg.3 PUSCH (i.e., a PUSCH scheduled by RAR UL grant or DCI format 0-0 with CRC scrambled by TC-RNTI) has been scheduled for a UE, it represents that the repetition transmission for PUSCH before RRC reconfiguration (i.e., before receiving a higher layer parameter carrying ‘RRCReconfiguration’) has been triggered.

In various embodiments, methods include defining trigger condition for repetition of PUSCH transmission before RRC Reconfiguration, and thus, the repetition of PUSCH transmission may be triggered effectively.

### Embodiment 2

The present disclosure describes non-limiting embodiments for requesting repetition of PUSCH transmission before RRC Reconfiguration. Some methods may include requesting repetition of PUSCH transmission before RRC Reconfiguration (i.e., before receiving a higher layer parameter carrying ‘RRCReconfiguration’). The PUSCH before RRC reconfiguration may be a PUSCH carrying the higher layer parameter ‘RRCSetupComplete’ (e.g., Msg.5 PUSCH) or a PUSCH carrying the higher layer parameter ‘UECapabilityInformation’. In some implementations, the PUSCH is scheduled by a DCI format 0_0 or DCI format 0_1 with CRC scrambled by a C-RNTI or CS-RNTI or MCS-C-RNTI.

The methods for requesting repetition of PUSCH transmission before RRC Reconfiguration may be defined as at least one of the following methods.

For a first method, a PRACH resource set (or called as the first PRACH resource set), which includes one or more PRACH resource, may be configured for one or more UE for requesting repetition of PUSCH transmission before RRC Reconfiguration. The PRACH resource may be at least one of preamble sequence resource or RACH occasion resource. When a UE wants to request repetition of PUSCH transmission before RRC Reconfiguration (other than Msg.3 PUSCH), it may use one PRACH resource from the first PRACH resource set for transmitting PRACH.

In some implementations, the first PRACH resource set for requesting repetition of PUSCH transmission before RRC Reconfiguration may be partly overlapping with PRACH resource set (or called as the second PRACH resource set) for requesting of PUSCH transmission scheduled by RAR UL grant and DCI format 0_0 with CRC scrambled by TC-RNTI. When a UE selects a PRACH resource from the overlapping part between the first PRACH resource set and the second PRACH resource set, it represents that the UE requests repetition for both of PUSCH transmission before RRC Reconfiguration and PUSCH transmission scheduled by RAR UL grant and DCI format 0_0 with CRC scrambled by TC-RNTI. When a UE selects a PRACH resource from the first PRACH resource set, but the PRACH resource is not included in the second PRACH resource set, it represents that the UE only requests repetition of PUSCH transmission before RRC Reconfiguration. When a UE selects a PRACH resource from the second PRACH resource set, but the PRACH resource is not included in the first PRACH resource set, it represents that the UE only requests repetition of PUSCH transmission scheduled by RAR UL grant and DCI format 0_0 with CRC scrambled by TC-RNTI.

For a second method, the repetition of PUSCH transmission before RRC Reconfiguration may be requested via Msg.3 PUSCH, which is scheduled by RAR UL grant or DCI format 0_0 with CRC scrambled by TC-RNTI. For a non-limiting example, a signaling is included in Msg.3 PUSCH for requesting the repetition of PUSCH transmission before RRC Reconfiguration.

In some implementations, the signaling is 1 bit. When a UE sets value of this bit to ‘1’ represents that the UE requests the repetition of PUSCH transmission before RRC Reconfiguration. When the UE sets value of this bit to ‘0’ represents that the UE doesn't request the repetition of PUSCH transmission before RRC Reconfiguration.

In some implementations, the signaling has two different values or status. For example, one is ‘requesting’, and another is ‘no requesting’. When the UE sets the value of signaling to ‘requesting’ represents that the UE requests the repetition of PUSCH transmission before RRC Reconfiguration. When the UE sets the value of signaling to ‘no requesting’ represents that the UE doesn't request the repetition of PUSCH transmission before RRC Reconfiguration.

In some implementations, present of the signaling represents that the UE requests the repetition of PUSCH transmission before RRC Reconfiguration, and the absent of the signaling represents that the UE doesn't request the repetition of PUSCH transmission before RRC Reconfiguration. Thus, a UE may indicate to the BS whether it requests the repetition of PUSCH transmission before RRC Reconfiguration by whether to include the signaling in Msg.3 PUSCH.

For a third method, a UE indicates, to the BS by using the transmission status of the Msg.3 and the indication information in the Msg.3 PUSCH, whether to request the repetition of PUSCH transmission before RRC Reconfiguration. The transmission status of the Msg.3 includes repetition transmission and no repetition transmission.

In some implementations, whether to request the repetition of PUSCH transmission before RRC Reconfiguration is same as whether to request the repetition of Msg.3 PUSCH by default. In addition, when a UE wants to change the request status, it may add an indication information in Msg.3 PUSCH.

More specifically, when a UE requests the repetition of Msg.3 PUSCH, and when there is no additional indication information in Msg.3 PUSCH for changing the request status, it represents that the UE also requests the repetition of PUSCH transmission before RRC Reconfiguration. When a UE requests the repetition of Msg.3 PUSCH, and when there is an additional indication information in Msg.3 PUSCH for changing the request status for repetition of PUSCH transmission before RRC Reconfiguration, it represents that the UE doesn't request the repetition of PUSCH transmission before RRC Reconfiguration. When a UE doesn't request the repetition of Msg.3 PUSCH, and when there is no additional indication information in Msg.3 PUSCH for changing the request status, it represents that the UE also doesn't request the repetition of PUSCH transmission before RRC Reconfiguration. When a UE doesn't request the repetition of Msg.3 PUSCH, and when there is an additional indication information in Msg.3 PUSCH for changing the request status for repetition of PUSCH transmission before RRC Reconfiguration, it represents that the UE requests the repetition of PUSCH transmission before RRC Reconfiguration.

In some implementations, when a UE requests the repetition of Msg.3 PUSCH, it represents that the UE also requests the repetition of PUSCH transmission before RRC Reconfiguration by default. When a UE doesn't request the repetition of Msg.3 PUSCH, there may be an additional indication information in Msg.3 PUSCH for indicating whether to change the request status for repetition of PUSCH transmission before RRC Reconfiguration. For example, the indication information can be ‘1 bit’ signaling. When the UE set the value of this bit to ‘0’ represents that changing the request status to requesting the repetition of PUSCH transmission before RRC Reconfiguration. When the UE sets the value of this bit to ‘1’ represents that the UE doesn't change the request status, i.e., still not requesting the repetition of PUSCH transmission before RRC Reconfiguration. In another example, the indication information can be two values or status, such as, ‘requesting’ and ‘no requesting’. The UE may set the indication information to one of the values for indicating corresponding request status of repetition of PUSCH transmission before RRC Reconfiguration. In another example, the present or absent of the indication information is used for indicating whether to change the request status. That is, the present of the indication information represents that the UE changes the request status to requesting the repetition of PUSCH transmission before RRC Reconfiguration. When the absent of the indication information represents that doesn't change the request status, i.e., still not requesting the repetition of PUSCH transmission before RRC Reconfiguration.

In some implementations, when a UE doesn't request the repetition of Msg.3 PUSCH, it represents that the UE also doesn't request the repetition of PUSCH transmission before RRC Reconfiguration by default. When a UE requests the repetition of Msg.3 PUSCH, there may be an additional indication information in Msg.3 PUSCH for indicating whether to change the request status for repetition of PUSCH transmission before RRC Reconfiguration.

For example, the indication information can be ‘1 bit’ signaling. The UE sets the value of this bit to ‘0’, representing to change the request status to not requesting the repetition of PUSCH transmission before RRC Reconfiguration. The UE sets the value of this bit to ‘1’, representing not to change the request status, i.e., requesting the repetition of PUSCH transmission before RRC Reconfiguration. In another example, the indication information can be two values or status, such as, ‘requesting’ and ‘no requesting’. The UE can set the indication information to one of the values for indicating corresponding request status of repetition of PUSCH transmission before RRC Reconfiguration. In another example, the present or absent of the indication information is used for indicating whether to change the request status. That is, the present of the indication information represents that the UE changes the request status to not requesting the repetition of PUSCH transmission before RRC Reconfiguration. The absent of the indication information represents that doesn't change the request status, i.e., requesting the repetition of PUSCH transmission before RRC Reconfiguration.

In various embodiments, methods include requesting repetition of PUSCH transmission before RRC Reconfiguration, and thus, the repetition of PUSCH transmission may be requested effectively.

### Embodiment 3

The present disclosure describes non-limiting embodiments for UE capability report for repetition of PUSCH transmission before RRC Reconfiguration. In some examples, a UE capability is defined for repetition transmission of PUSCH before RRC Reconfiguration. The UE capability is separated with that of repetition of PUSCH transmission scheduled by RAR UL grant and DCI format 0_0 with CRC scrambled by TC-RNTI. In some implementations, the PUSCH is scheduled by a DCI format 0_0 or DCI format 0_1 with CRC scrambled by a C-RNTI or CS-RNTI or MCS-C-RNTI. At least one of the following methods can be defined for UE capability report for repetition of PUSCH transmission before RRC Reconfiguration.

For a first method, a PRACH resource set (or called as the first PRACH resource set), which includes one or more PRACH resource, may be configured for UEs for reporting the UE capability on repetition of PUSCH transmission before RRC Reconfiguration. The PRACH resource may be at least one of preamble sequence resource or RACH occasion resource. When a UE wants to report the UE capability on repetition of PUSCH transmission before RRC Reconfiguration, it can use one PRACH resource from the first PRACH resource set for transmitting PRACH.

For a second method, a UE capability on repetition of PUSCH transmission before RRC Reconfiguration may be reported via Msg.3 PUSCH, which is scheduled by RAR UL grant or DCI format 0_0 with CRC scrambled by TC-RNTI. For example, a signaling is included in Msg.3 PUSCH for reporting the UE capability on the repetition of PUSCH transmission before RRC Reconfiguration. More specifically, the signaling is 1 bit. A UE may set value of this bit to ‘1’, representing that the UE has the UE capability on the repetition of PUSCH transmission before RRC Reconfiguration. The UE may set value of this bit to ‘0’, representing that the UE hasn't the UE capability on the repetition of PUSCH transmission before RRC Reconfiguration.

In some implementations, the signaling has two different values or status. For example, one is ‘capable’, and another is ‘incapable’. The UE may set the value of signaling to ‘capable’, representing that the UE has the capability on the repetition of PUSCH transmission before RRC Reconfiguration. The UE may set the value of signaling to ‘incapable’, representing that the UE doesn't has the capability on the repetition of PUSCH transmission before RRC Reconfiguration.

In some implementations, present of the signaling represents that the UE has the capability on the repetition of PUSCH transmission before RRC Reconfiguration, and the absent of the signaling represents that the UE doesn't has the capability on the repetition of PUSCH transmission before RRC Reconfiguration. So a UE may indicate to the BS whether it has the capability on the repetition of PUSCH transmission before RRC Reconfiguration by whether to include the signaling in Msg.3 PUSCH.

For a third method, the UE indicates to the BS by using the transmission status of the Msg.3 and the indication information in the Msg.3 PUSCH, whether it has the capability on the repetition of PUSCH transmission before RRC Reconfiguration. The transmission status of the Msg.3 includes repetition transmission and no repetition transmission.

In some implementations, when the UE requests the repetition of Msg.3 PUSCH, and when there is no additional indication information in Msg.3 PUSCH for changing the capability status, it represents that the UE also has the capability on the repetition of PUSCH transmission before RRC Reconfiguration. When a UE requests the repetition of Msg.3 PUSCH, and when there is an additional indication information in Msg.3 PUSCH for changing the capability status for repetition of PUSCH transmission before RRC Reconfiguration, it represents that the UE doesn't has the capability on the repetition of PUSCH transmission before RRC Reconfiguration. When a UE doesn't request the repetition of Msg.3 PUSCH, and when there is no additional indication information in Msg.3 PUSCH for changing the capability status, it represents that the UE also doesn't has the capability on the repetition of PUSCH transmission before RRC Reconfiguration. When a UE doesn't request the repetition of Msg.3 PUSCH, and when there is an additional indication information in Msg.3 PUSCH for changing the capability status for repetition of PUSCH transmission before RRC Reconfiguration, it represents that the UE has the capability on the repetition of PUSCH transmission before RRC Reconfiguration.

In some implementations, when a UE requests the repetition of Msg.3 PUSCH, it represents that the UE also has the capability on the repetition of PUSCH transmission before RRC Reconfiguration by default. When a UE doesn't request the repetition of Msg.3 PUSCH, there will be an additional indication information in Msg.3 PUSCH for indicating whether it has the capability on the repetition of PUSCH transmission before RRC Reconfiguration or not. For example, the indication information can be ‘1 bit’ signaling. The UE may set the value of this bit to ‘0’, representing that the UE has the capability on the repetition of PUSCH transmission before RRC Reconfiguration. The UE may set the value of this bit to ‘1’, representing that it doesn't have the capability on the repetition of PUSCH transmission before RRC Reconfiguration.

In some implementations, the indication information may be two values or status, such as, ‘capable’ and ‘incapable’. The UE may set the indication information to one of the values for indicating corresponding capability status of repetition of PUSCH transmission before RRC Reconfiguration.

In some implementations, the present or absent of the indication information is used for indicating whether it has the capability or not. That is, the present of the indication information represents that the UE has the capability on the repetition of PUSCH transmission before RRC Reconfiguration. The absent of the indication information represents that it doesn't have the capability on the repetition of PUSCH transmission before RRC Reconfiguration.

In some implementations, the UE capability is defined for repetition transmission of PUSCH before RRC Reconfiguration. The UE capability is same as either one of, UE capability for PUSCH repetitions over multiple slots, UE capability for PUSCH repetition Type A, and UE capability for repetition of PUSCH transmission scheduled by RAR UL grant and DCI format 0_0 with CRC scrambled by TC-RNTI. When the UE capability has already been reported via either method above, it will not be reported in ‘UECapabilityInformation’, or the related report via ‘UECapabilityInformation’ should align with the UE capability reported in the above way.

In various embodiments, methods include UE capability report for repetition of PUSCH transmission before RRC Reconfiguration, and thus, UE capability can be reported effectively.

### Embodiment 4

The present disclosure describes non-limiting embodiments for repetition factor indication for repetition of PUSCH transmission before RRC Reconfiguration. Some methods can be defined for indicating a repetition factor from BS to UE for transmitting PUSCH before RRC Reconfiguration. The repetition factor is used for indicating the number of repetitions for PUSCH transmission. The PUSCH before RRC reconfiguration may be a PUSCH carrying the higher layer parameter ‘RRCSetupComplete’ (e.g., Msg.5 PUSCH) or a PUSCH carrying the higher layer parameter ‘UECapabilityInformation’. In some implementations, the PUSCH is scheduled by a DCI format 0_0 or DCI format 0_1 with CRC scrambled by a C-RNTI or CS-RNTI or MCS-C-RNTI. The repetition factor for repetition of PUSCH transmission may be indicated by at least one of the following methods.

For a first method, a higher layer parameter can be used for configuring the repetition factor. In some examples, the higher layer parameter is transmitted before RRC Reconfiguration. In some examples, the higher layer parameter can be included in a PDSCH which is carrying RRCSetup or a PDSCH with UE contention resolution identity (e.g., Msg.4 PDSCH). In some examples, the higher layer parameter can be included in system information block1 (SIB1) PDSCH.

For a second method, a higher layer parameter (e.g., in BWP-UplinkCommon, or Msg.4 PDSCH) may be used for configuring a time domain resource allocation list (or time domain resource allocation Table) for PUSCH with repetition number. For example, the higher layer parameter can be ‘PUSCH-TimeDomainResourceAllocationList’, which includes ‘numberOfRepetitions’. Then, each time domain resource allocation (TDRA) in the time domain resource allocation list may correspond to a number of repetitions. Then, a DCI format (e.g., DCI format 0-0 or DCI format 0-1 or DCI format 0-2) may be used for scheduling a PUSCH with repetition. The repetition factor used for this PUSCH is indicated by Time domain resource assignment field in the DCI. The PUSCH may be a PUSCH carrying the higher layer parameter ‘RRCSetupComplete’ (e.g., Msg.5 PUSCH) or a PUSCH carrying the higher layer parameter ‘UECapability Information’.

For a non-limiting example, the higher layer parameter ‘PUSCH-TimeDomainResource AllocationList’ includes at most X (for a non-limiting example, X=16) different configurations, e.g., PUSCH-TimeDomainResourceAllocation. In each configuration, there is one parameter, e.g., numberOfRepetitions for indicating the repetition factor for the PUSCH transmission. Some candidate values of the repetition factor may be predefined, e.g., {n1, n2, n3, n4, n7, n8, n12, n16, n20, n24, n28, n32, spare4, spare3, spare2, spare1}, wherein, n1 represents repetition factor equals to 1, which also means no repetition. n2 represents repetition factor equals to 2, etc.

For another non-limiting example shown in Table 1, 16 different configurations may be provided via PUSCH-TimeDomainResourceAllocationList. There may be a time domain resource assignment field with 4 bits in the DCI format. The value of this four bits may refer to the index in the Table 1. More specifically, the configuration with index 2 may be used for PUSCH transmission when the value of time domain resource assignment field in the DCI format scheduling the PUSCH set to 0010. Then, the repetition factor for the PUSCH transmission is 4. The configuration with index 7 may be used for PUSCH transmission when the value of time domain resource assignment field in the DCI format scheduling the PUSCH sets to 0111. The repetition factor for the PUSCH transmission is 8.

TABLE 1
various configuration for repetition factor indication

| | Other configuration parameters | |
|---|---|---|
| | [e.g., at least one of, mapping | |
| | Type(TypeA or TypeB), starting | |
| | symbol and length for TypeA, | |
| | starting symbol for TypeB, | |
| | length for TypeB, K2(UL | Repetition |
| Index | scheduling timing), etc.] | factor |
| 0 | Configuration 1 | 1 |
| 1 | Configuration 1 | 2 |
| 2 | Configuration 1 | 4 |
| 3 | Configuration 2 | 1 |
| 4 | Configuration 2 | 2 |
| . . . | . . . | . . . |
| 7 | Configuration 3 | 8 |
| . . . | . . . | . . . |
| 15 | . . . | . . . |

For a third method, a UE may be provided via a higher layer parameter (e.g., in BWP-UplinkCommon, or SIB1, or Msg.4 PDSCH) a repetition factors list with at most M (e.g., M=4) values for a PUSCH transmission before RRC reconfiguration, or for a PUSCH transmission scheduled by a DCI format 0_0 with CRC scrambled by a C-RNTI or CS-RNTI or MCS-C-RNTI.

In some implementations, when the UE requests repetitions for the PUSCH transmission before RRC reconfiguration, the UE transmits the PUSCH over Y slots, where Y is indicated by the logy (e.g., 2) MSBs of the MCS field in the DCI format 0_0 from the repetition factors list or from RRC signaling ‘numberOfMsg3-RepetitionsList’ if the repetition factors list is not provided or from {1, 2, 3, . . . , M} (e.g., {1, 2,3, 4}) if both numberOfMsg3. RepetitionsList and the repetition factors list are not provided. Wherein, the higher layer parameter numberOfMsg3-RepetitionsList is used for indicating the repetition factor list for Msg.3 PUSCH repetition.

In some implementations, a UE may be provided via a higher layer parameter (e.g., in BWP-UplinkCommon, or SIB1, or Msg.4 PDSCH) a repetition factors list with at most N (e.g., N=3) values for a PUSCH transmission before RRC reconfiguration, or for a PUSCH transmission scheduled by a DCI format 0_0 with CRC scrambled by a C-RNTI or CS-RNTI or MCS-C-RNTI. When the UE requests repetitions for the PUSCH transmission before RRC reconfiguration, the UE transmits the PUSCH over Y slots, where Y is indicated by the ┌log₂N┐ (e.g., 2) MSBs of the MCS field in the DCI format 0_0 from the repetition factors list or from RRC signaling ‘numberOfMsg3-RepetitionsList’ if the repetition factors list is not provided or from {1, 2, . . . , N} (e.g., {1, 2,3}) if both numberOfMsg3-RepetitionsList and the repetition factors list are not provided. Wherein, the higher layer parameter numberOfMsg3-RepetitionsList is used for indicating the repetition factor list for Msg.3 PUSCH repetition.

In some implementations, the UE may be provided via a higher layer parameter (e.g., in BWP-UplinkCommon, or SIB1, or Msg.4 PDSCH) a MCS indexes list with at most eight values for a PUSCH transmission before RRC reconfiguration, or for a PUSCH transmission scheduled by a DCI format 0_0 with CRC scrambled by a C-RNTI or CS-RNTI or MCS-C-RNTI. The UE may determine an MCS for the PUSCH transmission by the 5-log₂M or 5-┌log₂N┐ (e.g., 3) LSBs of the MCS field in the DCI format 0_0. The 3 LSBs of the MCS information field of the DCI format 0_0 with CRC scrambled by the C-RNTI or CS-RNTI or MCS-C-RNTI provide a codepoint to determine the MCS index based on the configured MCS indexes list (e.g., {0, 1, 2, . . . , P−1}) or based on the higher layer parameter mcs-Msg3-Repetitions if the MCS indexes list is not configured or based on {0, 1, 2, 3, 4, 5, 6, 7} when both of the MCS indexes list and mcs-Msg3-Repetitions are not provided. Wherein, the higher layer parameter mcs-Msg3-Repetitions may be used for indicating an MSC indexes list for Msg.3 PUSCH repetition.

In some implementations, at least part bits of information field in DCI format 0-0 may be used for indicating the repetition factor. The information field includes at least one of, frequency domain resource assignment, time domain resource assignment, and/or HARQ process number and TPC command for scheduled PUSCH.

In various embodiments, methods include factor indication, and thus, the number of repetitions may be effectively indicated without additional signaling overhead and without significantly increasing the detection complexity of UEs.

The methods in various embodiments include at least one of trigger condition definition, requesting for repetition of PUSCH transmission, UE capability report for repetition of PUSCH transmission, and repetition factor indication, which may also be used for a PUSCH scheduled by a DCI format 0-0 with CRC scrambled by C-RNTI or CS-RNTI or MCS-C-RNTI, no matter whether it is before the RRC reconfiguration or not. In some implementations, whether one of the above methods can be used for a PUSCH scheduled by a DCI format 0-0 with CRC scrambled by C-RNTI or CS-RNTI or MCS-C-RNTI is indicated via a higher layer parameter, e.g., in SIB1 or Msg.4 or UE specific RRC signaling or a MAC layer signaling. In some implementations, whether one of the above methods can be used for a PUSCH scheduled by a DCI format 0-0 with CRC scrambled by C-RNTI or CS-RNTI or MCS-C-RNTI is related with UE reporting, e.g., when a UE reports corresponding UE capability or request, the methods described in the present disclosure may be used for the PUSCH scheduled by a DCI format 0-0 with CRC scrambled by C-RNTI or CS-RNTI or MCS-C-RNTI.

The present disclosure describes methods, apparatus, and computer-readable medium for wireless communication. The present disclosure addressed the issues with repetitions for PUSCH transmission. The methods, devices, and computer-readable medium described in the present disclosure may facilitate the performance of wireless communication by indicating and/or configuring repetition transmission of physical uplink shared channel (PUSCH), thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
sending, by a user equipment (UE) to a base station, a request or a capability indication for a repetition of a first physical uplink shared channel (PUSCH) transmission; and
receiving, by the UE from the base station, a repetition factor indication for the repetition of the first PUSCH transmission.

2. The method according to claim 1, further comprising:
after sending a second PUSCH transmission or before sending a third PUSCH transmission, transmitting, by the UE to the base station, the repetition of the first PUSCH transmission; wherein:
the second PUSCH transmission comprises one of a PUSCH scheduled by a random access response (RAR) uplink (UL) grant, or a PUSCH scheduled by a downlink control information (DCI) format 0_0 with a cyclic redundancy check (CRC) scrambled by a temporary cell-radio network temporary identifier (TC-RNTI), or
the third PUSCH transmission comprises a PUSCH carrying radio resource control (RRC) reconfiguration complete information.

3. A method for wireless communication, comprising:
receiving, by a base station from a user equipment (UE), a request or capability indication for a repetition of a first physical uplink shared channel (PUSCH) transmission; and
sending, by the base station to UE from, a repetition factor indication for the repetition of the first PUSCH transmission.

4. The method according to claim 3, further comprising:
after receiving a second PUSCH transmission or before receiving a third PUSCH transmission, receiving, by the base station from the UE, the repetition of the first PUSCH transmission; wherein:
the second PUSCH transmission comprises one of a PUSCH scheduled by a random access response (RAR) uplink (UL) grant, or a PUSCH scheduled by a downlink control information (DCI) format 0_0 with a cyclic redundancy check (CRC) scrambled by a temporary cell-radio network temporary identifier (TC-RNTI), or
the third PUSCH transmission comprises a PUSCH carrying radio resource control (RRC) reconfiguration complete information.

5. The method according to claim 1, wherein:
the first PUSCH transmission comprises at least one of the following:
a PUSCH carrying RRC setup complete information,
a PUSCH carrying UE capability information,
a PUSCH scheduled by a DCI format 0_0 with a CRC scrambled by a cell-RNTI (C-RNTI), a configured scheduling (CS-RNTI), or a modulation and coding scheme cell-RNTI (MCS-C-RNTI), or
a PUSCH scheduled by a DCI format 0_1 with a CRC scrambled by a cell-RNTI (C-RNTI), a configured scheduling (CS-RNTI), or a modulation and coding scheme cell-RNTI (MCS-C-RNTI).

6. The method according to claim 1, wherein:
the UE sends the request or the capability indication for the repetition of the first PUSCH transmission in response to at least one of the following triggering conditions:
a synchronization signal (SS) reference signal received power (RSRP) measured by the UE being lower than an RSRP threshold,
the UE having requested repetition of the second PUSCH transmission, or
the repetition of the second PUSCH transmission being scheduled for the UE.

7. The method according to claim 6, wherein:
the RSRP threshold is scheduled by one of the following:
via a higher layer parameter, or
via a high layer parameter and an offset value.

8. The method according to claim 1, wherein:
the request or the capability indication for the repetition of the first PUSCH transmission via at least one of the following:
a PRACH resource from a first PRACH resource set corresponding to the repetition of the first PUSCH transmission,
signalling information in the second PUSCH, or
a transmission status of the second PUSCH transmission and an indication information in the second PUSCH.

9. The method according to claim 8, wherein:
the PRACH resource comprises at least one of a preamble sequence resource or a RACH occasion resource.

10. The method according to claim 8, wherein the request or the capability indication for the repetition of the first PUSCH transmission via the signalling information in the second PUSCH comprises:
setting the signalling information as a first value, representing that the UE has the capability or requests for the repetition of the first PUSCH transmission, or
setting the signalling information as a second value, representing that the UE does not have the capability or request for the repetition of the first PUSCH transmission.

11. The method according to claim 8, wherein the request or the capability indication for the repetition of the first PUSCH transmission via the transmission status of the second PUSCH transmission and the indication information in the second PUSCH comprises at least one of the following:
in response to the UE having requested repetition of the second PUSCH transmission, setting no indication information in the second PUSCH, representing that the UE has the capability or requests for the repetition of the first PUSCH transmission,
in response to the UE having requested repetition of the second PUSCH transmission, setting the indication information in the second PUSCH, representing that the UE does not have the capability or request for the repetition of the first PUSCH transmission,
in response to the UE does not request repetition of the second PUSCH transmission, setting no indication information in the second PUSCH, representing that the UE does not have the capability or request for the repetition of the first PUSCH transmission, or
in response to the UE does not request repetition of the second PUSCH transmission, setting the indication information in the second PUSCH, representing that the UE has the capability or requests for the repetition of the first PUSCH transmission.

12. The method according to claim 8, wherein the request or the capability indication for the repetition of the first PUSCH transmission via the transmission status of the second PUSCH transmission and the indication information in the second PUSCH comprises at least one of the following:
in response to the UE having requested repetition of the second PUSCH transmission, representing that the UE has the capability or requests for the repetition of the first PUSCH transmission,
in response to that the UE does not request repetition of the second PUSCH transmission, setting the indication information in the second PUSCH to a first value, representing that the UE does not have the capability or request for the repetition of the first PUSCH transmission, or
in response to that the UE does not request repetition of the second PUSCH transmission, setting the indication information in the second PUSCH to a second value, representing that the UE has the capability or requests for the repetition of the first PUSCH transmission.

13. The method according to claim 8, wherein the request or capability indication for the repetition of the first PUSCH transmission via the transmission status of the second PUSCH transmission and the indication information in the second PUSCH comprises at least one of the following:
in response to the UE having requested repetition of the second PUSCH transmission, representing that the UE has the capability or requests for the repetition of the first PUSCH transmission,
in response to that the UE does not request repetition of the second PUSCH transmission, the present of the indication information in the second PUSCH, representing that the UE does not have the capability or request for the repetition of the first PUSCH transmission, or
in response to that the UE does not request repetition of the second PUSCH transmission, the absent of the indication information in the second PUSCH, representing that the UE has the capability or requests for the repetition of the first PUSCH transmission.

14. The method according to claim 8, wherein the request or capability indication for the repetition of the first PUSCH transmission via the transmission status of the second PUSCH transmission and the indication information in the second PUSCH comprises at least one of the following:
in response to that the UE does not request repetition of the second PUSCH transmission, representing that the UE does not have the capability or request for the repetition of the first PUSCH transmission,
in response to the UE having requested repetition of the second PUSCH transmission, setting the indication information in the second PUSCH to a first value, representing that the UE does not have the capability or request for the repetition of the first PUSCH transmission, or
in response to that the UE does not request repetition of the second PUSCH transmission, setting the indication information in the second PUSCH to a second value, representing that the UE has the capability or requests for the repetition of the first PUSCH transmission.

15. The method according to claim 8, wherein the request or capability indication for the repetition of the first PUSCH transmission via the transmission status of the second PUSCH transmission and the indication information in the second PUSCH comprises at least one of the following:
in response to that the UE does not request repetition of the second PUSCH transmission, representing that the UE does not have the capability or request for the repetition of the first PUSCH transmission,
in response to the UE having requested repetition of the second PUSCH transmission, the present of the indication information in the second PUSCH, representing that the UE has the capability or requests for the repetition of the first PUSCH transmission, or
in response to that the UE does not request repetition of the second PUSCH transmission, the absent of the indication information in the second PUSCH, representing that the UE does not have the capability or request for the repetition of the first PUSCH transmission.

16. The method according to claim 1, wherein:
the UE receives, from the base station, the repetition factor indication for the repetition of the first PUSCH transmission by at least one of the following:
a higher layer parameter for configuring the repetition factor,
a higher layer parameter for configuring a list of repetition factors and a signalling in a DCI for indicating the repetition factor in the list of repetition factors,
a higher layer parameter for configuring a list of M repetition factors and log₂M most significant bits (MSBs) of a modulation and coding scheme (MCS) field in a DCI for indicating the repetition factor in the list of M repetition factors, M being a positive integer, or
a higher layer parameter for configuring a list of N repetition factors and ┌log₂N┐ most significant bits (MSBs) of a modulation and coding scheme (MCS) field in a DCI for indicating the repetition factor in the list of N repetition factors, N being a positive integer and ┌ ┐ representing a ceiling function.

17. The method according to claim 16, wherein:
a configured list of repetition factors for repetition of the second PUSCH transmission is used for indicating repetition factor for repetition of the first PUSCH transmission, in response to that the higher layer parameter for configuring the list of M repetition factors for repetition of the first PUSCH transmission is not provided; or
a repetition factor list {1, 2, . . . , M} or {1, 2, . . . , N} is used for indicating repetition factor for repetition of the first PUSCH transmission, in response to that both of the list of M or N repetition factors for repetition of the first PUSCH transmission and configured list of repetition factors for repetition of the second PUSCH transmission are not provided.

18. The method according to claim 17, wherein:
5-log₂M or 5-┌log₂N┐ least significant bits (LSBs) of an MCS field in a DCI indicates an MCS index from a list of MCS indexes for the first PUSCH transmission,
a higher layer parameter is used for configuring the list of MCS indexes for the first PUSCH transmission,
a list of MCS indexes configured for the second PUSCH transmission is used for indicating the MCS index of the first PUSCH transmission, in response to that the higher layer parameter for configuring the list of MCS indexes for the first PUSCH transmission is not provided, or
a MCS index list {0, 1, 2, . . . , P−1} is used for indicating the MCS index for the first PUSCH transmission, in response to that both of the list of MCS indexes for the first PUSCH transmission and the list of MCS indexes for the second PUSCH transmission are not provided, P being a positive integer.

19. A wireless communications apparatus comprising at least one processor and a memory, wherein the at least one processor is configured to read code from the memory and implement a method recited in claim 1.
